(19) United States
(12) Patent Application Publication
(10) Pub. No.: US 2011/0143596 A1
(43) Pub. Date: Jun. 16, 2011

(54) SMART CARD CONNECTOR

(76) Inventor: Alan D. Crighton, Apex, NC (US)

(21) Appl. No.: 12/963,131

(22) Filed: Dec. 8, 2010

Related U.S. Application Data
(60) Provisional application No. 61/286,157, filed on Dec. 14, 2009.

(51) Int. Cl. H01R 24/00; H01R 13/46

(52) U.S. Cl. 439/626; 439/892

(57) ABSTRACT

A smart card connector may include a connector housing connected to a cover. The connector housing and the cover may define a channel for receiving the smart card. The connector may receive the smart card in an insertion direction. When the smart card is inserted into the smart card connector, contacts secured within the connector housing may establish an electrically conductive connection with contact pads on the surface of the smart card. The connector housing may be narrower than the cover in a second direction that is perpendicular to the first direction. The connector housing may define a first centerline that extends along the insertion direction, and the cover may define a second centerline that extends along the insertion direction. The first centerline may be offset from the second centerline.

### CROSS-REFERENCE TO RELATED APPLICATIONS

This application claims priority to U.S. Provisional Patent Application Ser. No. 61/286,157, filed on Dec. 14, 2009, the disclosure of which is hereby incorporated by reference as if set forth in its entirety herein.

### BACKGROUND

Plastic cards with embedded electrical circuitry are typically known as smart cards. Smart cards may also be known as chip cards or integrated circuit cards. Smart cards may provide electrically conductive contacts to provide an electrical interface between a card reader and the electrical circuitry embedded in the card. The electrically conductive contacts may be arranged as a contact pad on the face of the card, for example. The embedded electrical circuitry may provide memory, processor logic, and/or a combination of both. Smart cards may be in any format and size, for example “credit card” size.

An example smart card is a Subscriber Identification Module (SIM) card. The SIM card electrically stores information pertaining to a mobile communications device, such as a cellular telephone or wireless modem. The SIM card may store a unique serial number associated with a mobile user. The mobile user may insert the SIM card into any cooperative mobile device, and the operation of that device will be attributed to the mobile user, by way of the unique serial number.

Electrical systems, such as the mobile communications device described above, that interface with smart cards may provide a connector to interface with a smart card. The connector may receive the smart card, secure it in place, and provide an electrically connective path between the electrical system and the smart card. Thus, the memory and/or processor logic of the smart card may interact with the electrical system. In some cases, the electrical systems may use surface mount technology, so the physical size of the electrical system may depend on the extent that the connector occupies space on a circuit board within the electrical system.

### SUMMARY

In accordance with one embodiment, an electrical connector is configured to receive a smart card. The electrical connector includes a connector housing that defines first and second slots. The electrical connector further includes a cover having first and second opposed side walls that at least partially define an internal void configured to receive the smart card along an insertion direction. The cover further includes first and second mounting tabs connected to the first and second opposed side walls, respectively, wherein the first and second mounting tabs each received in a corresponding one of the first and second slots.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the present disclosure, reference to the drawings is made. The scope of the disclosure is not limited, however, to the specific instrumentalities disclosed in the drawings. In the drawings:

FIG. 1 is a schematic top plan view of an example smart card;

FIG. 2A is a top perspective view of smart card connector constructed in accordance with one embodiment, including a connector body and a cover mounted onto the connector body;

FIG. 2B is a bottom perspective view of the smart card connector illustrated in FIG. 2A;

FIG. 2C is a top plan view of the smart card connector illustrated in FIG. 2A;

FIG. 3A is a perspective view of the smart card connector body illustrated in FIG. 2A;

FIG. 3B is a side elevation view of the connector body illustrated in FIG. 3A;

FIG. 3C is a top plan view of the smart card connector body illustrated in FIG. 3A;

FIG. 4 is an end elevation view of the cover illustrated in FIG. 2A;

FIG. 5A is an assembly view of a smart card assembly including the smart card illustrated in FIG. 1 and the smart card connector illustrated in FIG. 2A, showing insertion of the smart card into the smart card connector;

FIG. 5B is a top plan view of the smart card assembly illustrated in FIG. 5A, showing the smart card mated with the smart card connector;

FIG. 6 is a schematic top plan view of a substrate configured to electrically connect with the smart card connector illustrated in FIG. 2A, showing an electrical layout pattern of the substrate;

FIG. 7A is a bottom perspective view of a smart card connector constructed in accordance with another alternative embodiment;

FIG. 7B is a top perspective view the smart card connector illustrated in FIG. 7A;

FIG. 7C is a top plan view of the smart card connector illustrated in FIG. 7A;

FIG. 7D is a bottom perspective view of a smart card connector assembly including a smart card inserted into and mated with the smart card connector illustrated in FIGS. 7A-C;

FIG. 8A is a bottom perspective view of a smart card connector constructed in accordance with another alternative embodiment;

FIG. 8B is a top perspective view of the smart card connector constructed illustrated in FIG. 8A;

FIG. 9A is a perspective view of a smart card connector including a smart card connector body and a cover mounted onto the connector body, wherein the cover includes pressure dimples;

FIG. 9B is a top plan view of the smart card connector illustrated in FIG. 9A;

FIG. 10A is a bottom perspective view of a smart card connector constructed in accordance with an alternative embodiment, including a cover mounted onto a connector body;

FIG. 10B is a top perspective view of the connector body illustrated in FIG. 10A;

FIG. 10C is a bottom perspective view of the connector body illustrated in FIG. 10A;

FIG. 11A is a bottom perspective view of a smart card connector constructed in accordance with another alternative embodiment, including a cover mounted onto a connector body; and

FIG. 11B is a top perspective view of the connector body illustrated in FIG. 11A.

### DETAILED DESCRIPTION

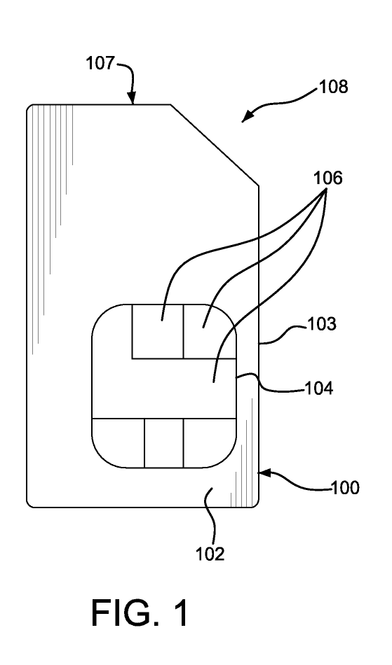

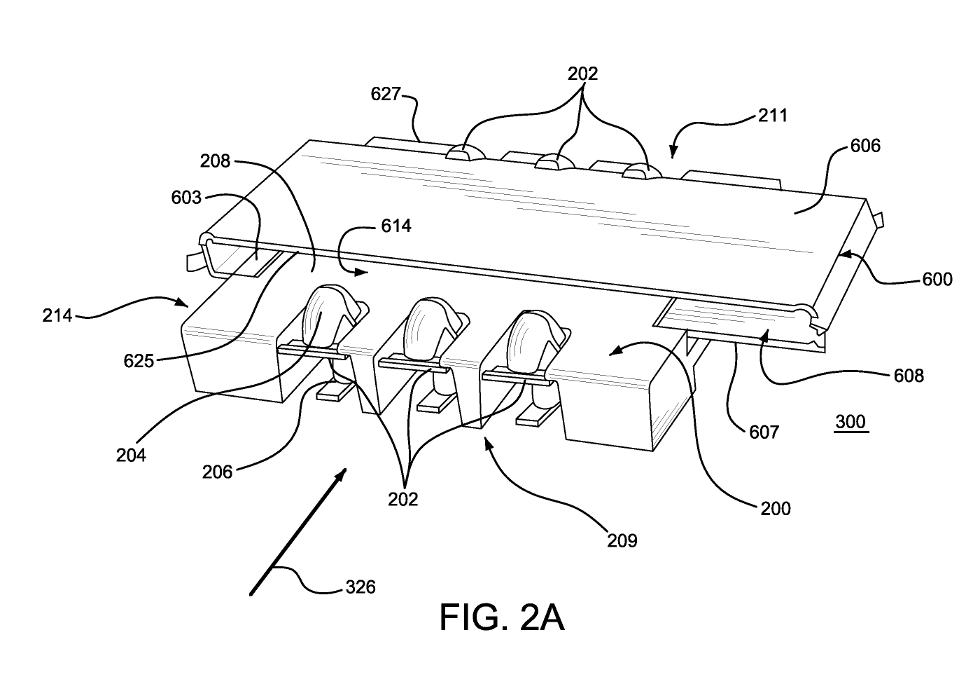

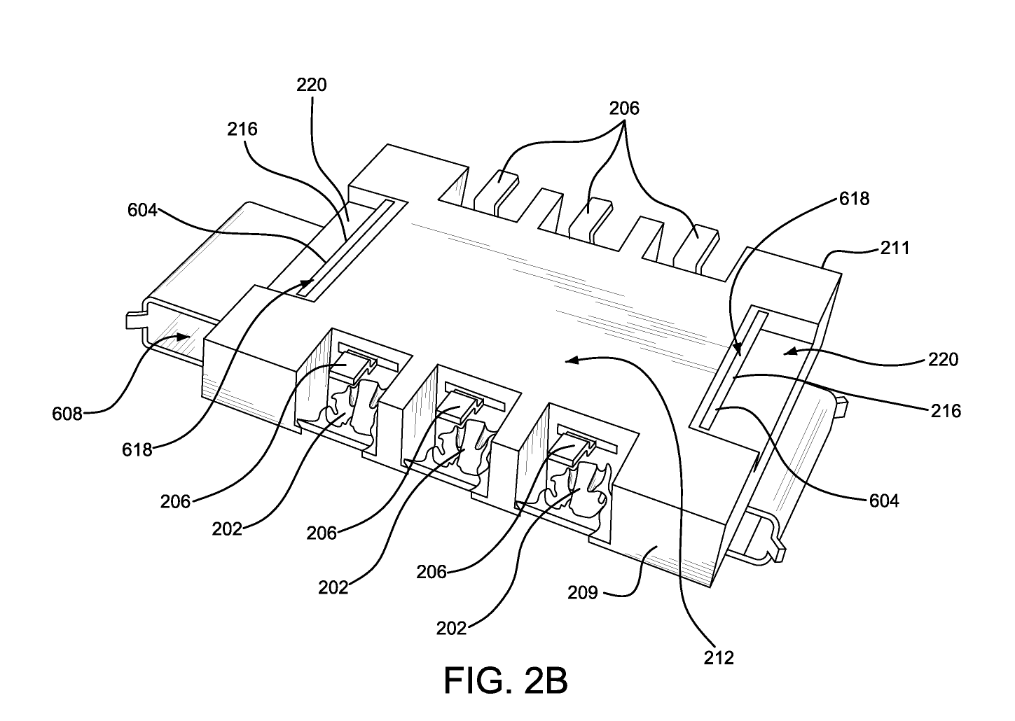

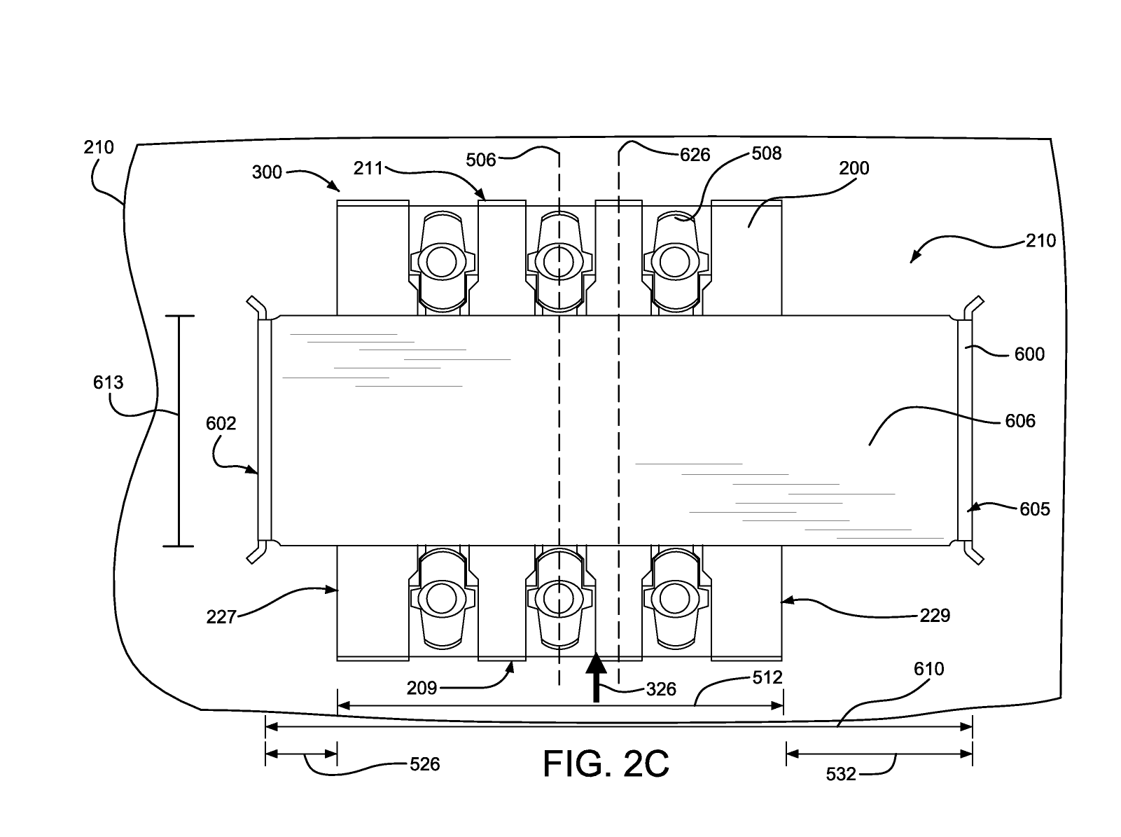

Referring to FIG. 1, an example smart card 100 includes include a card body 102 that carries an electrical contact pad 104. The card body 102 may be dielectric or insulative, and made of plastic, cardboard, or any suitable alternative material. The electrical contact pad 104 includes one or more electrical contacts 106, such as six electrical contacts 106 as illustrated or any number of electrical contacts as desired. The electrical contacts 106 can define any size, shape, and spatial relationship as desired. The card body 102 includes embedded circuitry, such as an electronic memory, electronic processor logic, and/or a combination of the two. The embedded circuitry of the smart card 100 can be in electrical communication with at least one of the electrical contacts 106, and can communicate with a cooperative device, such as a card reader, when the smart card 100 is connected to the cooperative device via an electrical connector, such as a smart card connector 300 (see FIG. 2A). The smart card connector 300 can establish an electrically conductive path between circuits of the cooperative device and the electrical contacts 106.

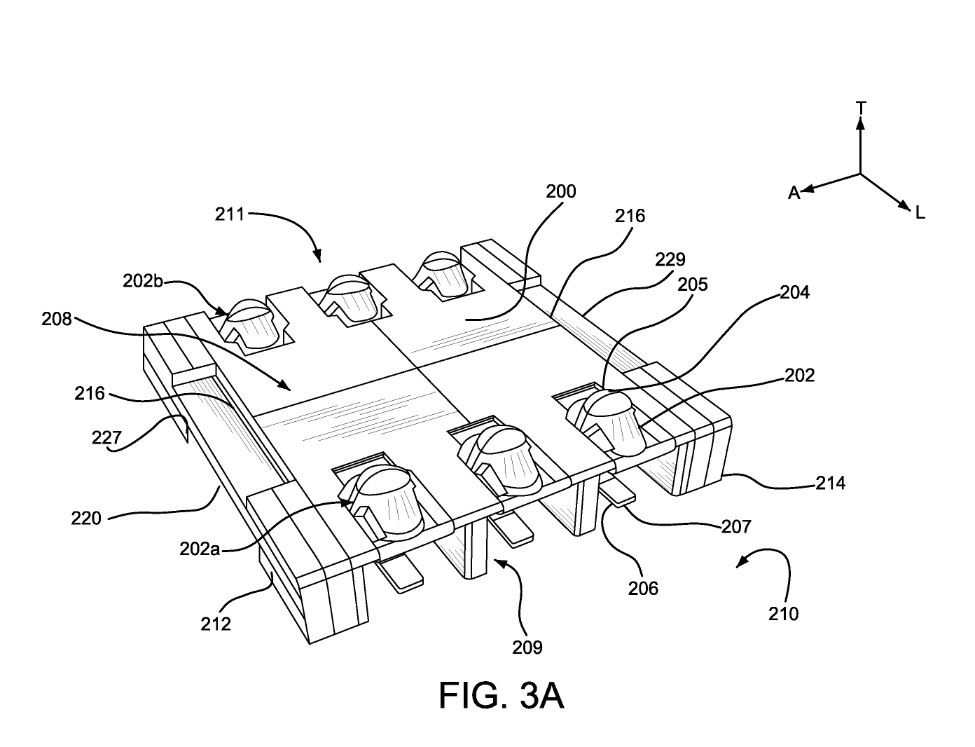

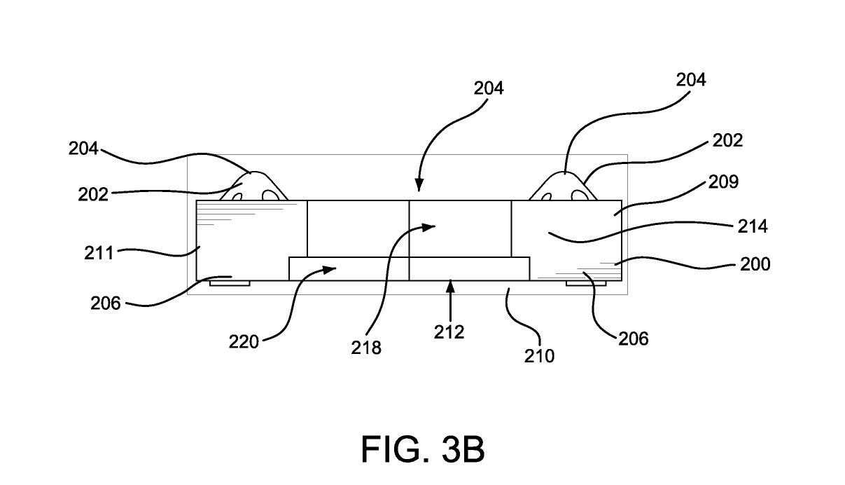

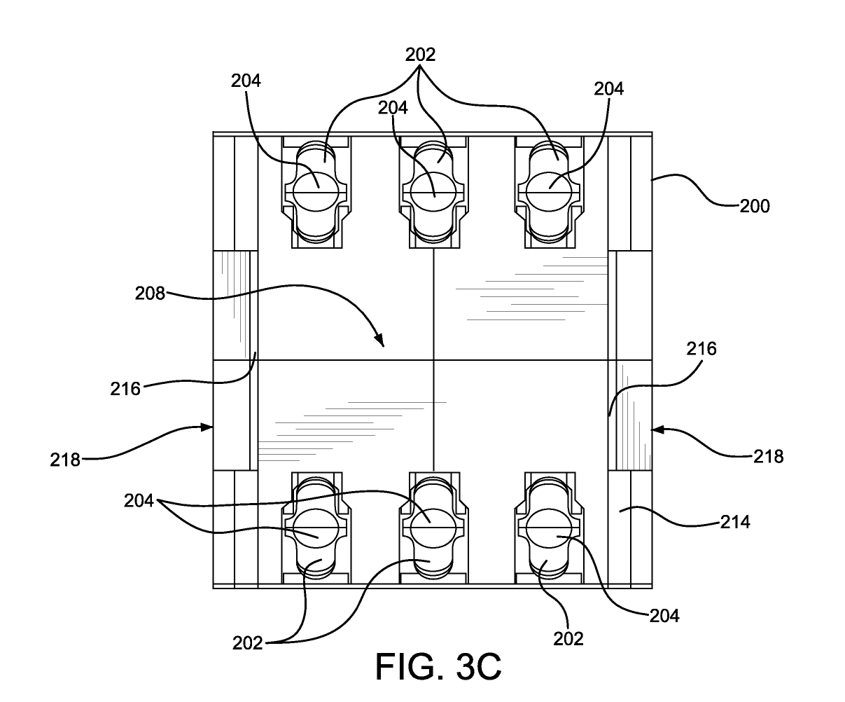

The smart card body 102 can be keyed so as to be asymmetrical such that the electrical contacts 106 mate with complementary electrical contacts 202 (see FIGS. 2A-3C) of the smart card connector 300 when the smart card 100 is inserted into the smart card connector 300 in a desired insertion orientation, while preventing the electrical contacts 106 from mating with the electrical contacts 202 when the smart card 100 connector is inserted into the smart card 102 in an undesired orientation. For instance, one side of the smart card body 102 can define an asymmetrical orientation insertion tip 107 that can define a notch 108 as illustrated, or can alternatively define a projection, so as to provide asymmetry to the card body 102.

The smart card 100 can be provided as a Subscriber Identification Module (SIM) card that can electronically store information pertaining to a mobile communications device, such as a cellular telephone or wireless modem. SIM cards may store unique serial number associated with the mobile user, such that when the SIM card is inserted by the mobile user into a cooperative mobile device, the operation of that device may be attributed to the mobile user by way of the unique serial number. The unique serial number may be stored in embedded electronic memory.

Referring now to FIGS. 2A-3C, the smart card connector 300 constructed in accordance with one embodiment includes a connector body 214 and a cover 600 mounted or otherwise attached to the connector body 214. The connector body 214 includes a dielectric or insulative connector housing 200 and one or more electrical contacts 202 carried by the connector housing 200. The cover 600 can be mounted or otherwise attached to the connector housing 200.

The connector housing 200 defines laterally opposed side walls 227 and 229, and longitudinally opposed front and rear ends 209 and 211, and transversely opposed upper and lower surfaces 208 and 212, respectively. Thus, the electrical connector 300 extends horizontally along a longitudinal direction L, horizontally along a lateral direction A that is substantially perpendicular to the longitudinal direction L, and vertically along a transverse direction T that is substantially perpendicular to the longitudinal direction L and the lateral direction A. While the longitudinal direction L and the lateral direction A extend horizontally as illustrated, and the transverse direction T extends vertically, it should be appreciated that these directions may change depending, for instance, on the orientation of the electrical connector 300 during use. Unless otherwise specified herein, the terms “lateral,” “longitudinal,” and “transverse” are used to describe the perpendicular directional components of various components. The terms “inboard” and “inner,” and “outboard” and “outer” with respect to a specified directional component are used herein with respect to a given apparatus to refer to directions along the directional component toward and away from the center apparatus, respectively.

The connector housing 200 can be made of any suitable dielectric material, such as plastic or the like, and can carry both the electrical contacts 202 and the cover 600. The upper surface 208 can be a substantially planar surface suitable for facilitating engagement with a substantially flat smart card, such as the smart card 100 illustrated in FIG. 1. The lower surface 212 may be configured to mount to an underlying substrate or printed circuit board 210, which can be provided as a printed circuit board that extends in a horizontal plane, or along the longitudinal and lateral directions, in accordance with the illustrated orientation. The lower surface 212 may be flat, and thereby configured to be flush with the printed circuit board 210 when the connector housing 200 is mounted onto the printed circuit board 210.

The connector housing 200 can define a mating interface at the upper surface 208 that is configured to mate with a smart card such as the smart card 100, and a mounting interface at the lower surface 212 that is configured to mate with a substrate such as a printed circuit board 210. The electrical contacts 200 define respective mating ends 204 disposed proximate to the mating interface that are configured to mate with the electrical contacts 106 of the smart card 100, and opposed mounting ends 206 that are configured to electrically connect to electrical pads or traces of the underlying printed circuit board 210 so as to place the printed circuit board 210 in electrical communication with the smart card 100.

The electrical contacts 202 may be made from any electrically conductive material, and are configured to transfer electrical signals, for instance between the smart card 100 and the printed circuit board 210. For example, the mating ends 204 of the electrical contacts 202 can be substantially spoon-shaped and define a convex raised portion 205 that protrudes out from the connector housing 200, for instance out from the upper surface 208, though it should be appreciated that the electrical contacts 202 can assume any geometric configuration as desired. The raised portion 205 is configured to mate with one of the contacts 106 of the smart card 100 that is mated with the connector at a location above the upper surface 208. The electrical contacts 202 may be spring-loaded such that the raised portion of the mating end 204 is compressible. For example when the smart card 100 is inserted into the smart card connector, the contact pad 104 of the smart card 100 can be positioned substantially flush to the upper surface 208 of the connector housing 200 such that the mating end 204 of the electrical contact 202 is compressed and maintains contact and electrical conductivity between the electrical contact 202 and the contact of the smart card 100.

The mounting end 206 of each contact 202 may protrude beyond the lower surface 212 of the connector housing 200, and can be configured as desired to establish an electrical connection between the electrical contact 202 and a electrically conductive trace on the printed circuit board 210. For example, the mounting ends 206 may define a footing 207 configured to be reflowed to a corresponding solder pad on a printed circuit board. Alternatively, the mounting ends 206 can be configured as press-fit terminals configured to be press-fit into a hole in the printed circuit board 210.

The electrical contacts 202 can define an orientation that corresponds to the orientation of the electrical contacts 106 on the contact pad 104 of the smart card 100. For example, the smart card 100 illustrated in FIG. 1 includes six contacts 106 and the electrical connector 300 can likewise include six contacts 202. The electrical contacts 202 can be oriented such that the mating ends 204 define a spatial relationship that is substantially equal to that of the corresponding electrical contacts 106 such that complementary ones of the electrical contacts 202 and 106 electrically connect when the smart card 100 is inserted into the connector housing 200 in the desired orientation. In accordance with the illustrated embodiment, a first group 202a of three laterally spaced contacts 202 is disposed adjacent the front end 209 of the connector housing 200, and a second group 202b of three laterally spaced contacts 202 is disposed adjacent the rear end 211 of the connector housing 200.

The connector body 214 can include one or more slots 216 that may each be spaced apart from one another and may each be substantially parallel to one another. The slots 216 extend through the connector housing 200 that facilitate connection of the cover 600 to the connector housing 200. As illustrated in FIGS. 3A and 3C, the slots 216 extend vertically through the connector housing 200 from the upper surface 208 through the lower surface 212. The slots 216 may be shaped as longitudinally elongated rectangular slots as illustrated, or can alternatively be shaped as round holes, or any other shape suitable for securing a cover, such as the cover 300, to the connector body 214, as will be described in more detail below. For instance, first and second slots 216 may be positioned adjacent to, and laterally inwardly recessed from, one or more side walls 227 and 229 of the connector housing 200 as illustrated. It should be appreciated that the slots 216 can be positioned anywhere relative to the connector housing 200 that provides a connection to the cover and without interfering with the connection of the electrical contacts 106 of the smart card 100 to the electrical contacts 202 of the smart card connector 300.

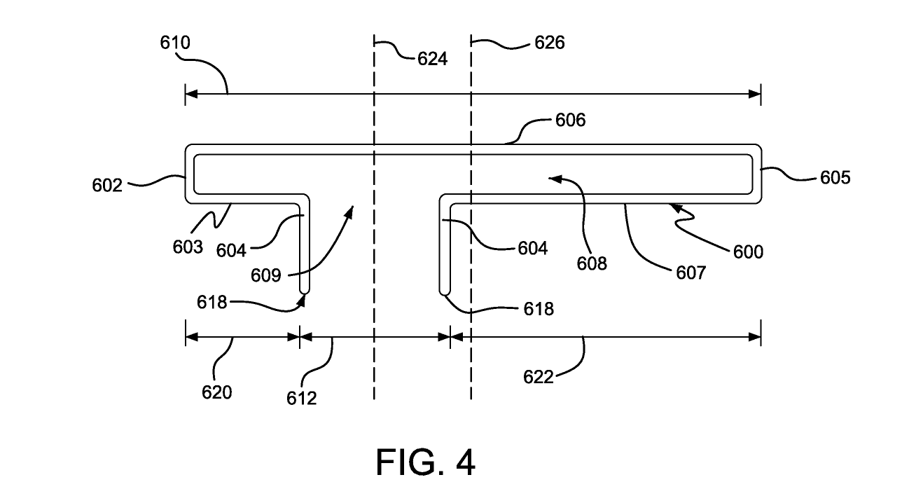

Referring now to FIGS. 2A-C and FIG. 4, the cover 600, which can be conductive and made of any suitable metal or any suitable alternative material, includes laterally opposed side walls 602 and 605, an upper wall 606 that is connected between the upper ends of the side walls 602 and 605, and a pair of flanges 603 and 607 that are connected to and extend laterally inward from the lower ends of the side walls 602 and 605, respectively. In accordance with the illustrated embodiment, the flange 603 defines a lateral dimension that is less than the lateral dimension of the flange 607, though the flange 603 could alternative extend laterally inward greater than the flange 607. Thus, the flange 603 extends laterally inward from the corresponding side wall 602 a distance that is different than the lateral distance that the flange 607 extends inward from the corresponding side wall 605.

The cover 600 further includes first and second mounting tabs 604 that extend down from the laterally inner ends of the respective flanges 603 and 607. The mounting tabs 604 can be sized to be disposed in the corresponding first and second slots 216 that extend through the connector housing 200. During operation, the cover 600 is mounted to the connector housing 200 by inserting the mounting tabs 604 into the slots 216 along a direction from the upper surface 208 toward the lower surface 212. The cover 600 can be substantially ‘T’ shaped in lateral cross section or from an end elevation view. The cover 600 defines a first lateral width 610 measured between the side walls 602 and 605, and a second lateral width 612 measured between the mounting tabs 604. In accordance with the illustrated embodiment, the first lateral width 610 is greater than the second lateral width 612.

The cover 600 can at least partially define an internal void 608 disposed between the upper wall 606, the side walls 602 and 605, and the inwardly extending flanges 603 and 607. Thus, at least one or more, up to all, of the upper wall 606, the side walls 602 and 605, and the inwardly extending flanges 603 and 607 at least partially define the internal void 608. The internal void 608 defines a mouth 609 disposed between the mounting tabs 604. The internal void 608 is sized and configured to receive the smart card 100 therein, such that the contact pad 104 of the smart card 100 is positioned at the mouth 609, or between the mounting tabs 604 so that the cover 600 does not interfere with the connection of the electrical contacts 106 of the smart card 100 and the contacts 204 of the connector housing 200. Otherwise stated, the contact pad 104 is received at a location between the side walls 602 and 605, and in particular between the mounting tabs 604. The mounting tabs 604 can define corresponding leading ends 618, with respect to insertion into the slots 216, that are suitable to be soldered to the underlying printed circuit board 210. It should be appreciated that the mounting tabs 604 can be provided in the shape as illustrated, or can alternatively be provided as pins or other suitable structure that extend into complementary apertures formed in the connector housing 200.

When the cover 600 is mounted to the connector housing 200, the connector housing, 200, and in particular the upper surface 208 of the connector housing 200, extends across the mouth 609 of the void 608 so as to enclose the void 608. Thus, it can be said that the void 608 is at least partially defined by the cover 600, and is substantially enclosed by the connector housing 200 so as to define a retention channel 614 which can include the internal void 608 having at least a portion of the mouth 609 closed by the connector housing 200 along an insertion direction 326 when the cover 600 is mounted onto the connector housing 200. In accordance with the illustrated embodiment, the insertion direction 326 is longitudinal along a direction from the front end 209 toward the rear end 211. Alternatively, the insertion direction 326 could be along a direction from the rear end 211 toward the front end 209 as desired. The smart card connector 300 is configured to receive the smart card 100 in the retention channel 614, and thus in the internal void 608 along an insertion direction 326. Thus, the cover 600 and the connector housing 200 combine to at least partially define the retention channel 614. When the smart card 100 is disposed in the retention channel, the cover 600, for instance the side walls 602 and 605 of the cover 600, prevent the smart card 100 from moving relative to the connector housing 200 along a direction that is substantially perpendicular to the insertion direction 326 and substantially parallel to the printed circuit board 210 when the electrical connector 300 is mounted to the printed circuit board 210. The side walls 602 and 605 of the cover 600 thus also prevent the smart card 100 from translating along the mating ends 204 and the mating interface.

It should be appreciated that the connector 300 defines an engagement member, for instance the slots 216 that extend along the respective side walls, and the cover 600 defines a complementary engagement member, for instance the mounting tabs 604, and that the complementary engagement members of the connector 300 and the cover 600 that engage along the side walls of the connector housing 200 at a location above the underlying printed circuit board 210 so as to restrict movement of the cover 600 relative connector housing 200 along a direction perpendicular to the insertion direction (e.g., the longitudinal direction and/or the lateral direction). In accordance with the illustrated embodiment, engagement of the engagement members of the electrical connector 300 and the cover 600 restricts movement of the cover 600 with respect to the connector housing 200 along a direction substantially perpendicular to the insertion direction and parallel to the underlying printed circuit board 210 when the electrical connector 300 is mounted to the printed circuit board 210. Furthermore, the engagement members of the connector 300 and the cover 600 engage at a location above the mounting interface of the connector 300, or the lower surface 212 of the connector housing 200. The cover 600 at least partially defines a card guide in the form of the retention channel 614, that is at same side with respect to the mounting interface of the connector 300, or the lower surface 212, as the engagement members of the connector 300 and the cover 600, and is also on the same side with respect to the mounting interface of the connector 300, or the lower surface 212, as the upper wall 606 of the cover 600. In accordance with the illustrated embodiment, the card guide in the form of the retention channel 614 is disposed at same side with respect to the printed circuit board 210 as the engagement members of the connector 300 and the cover 600, and as the upper wall 606 of the cover 600, when the connector 300 is mounted to the printed circuit board 210.

With continuing reference to FIG. 4, the cover 600 further defines a first distance 620 extending laterally between the side wall 602 and the corresponding adjacent tab 604, a second distance 622 extending laterally between the side wall 605 and the corresponding adjacent tab 604, and a third distance 612 extending laterally between the mounting tabs 604. The first and second distances 620 and 622 can be different from each other, such that the substantial T-shape defined cover 600 can be an asymmetrical T-shape. While the first distance 620 is illustrated as being less than the second distance 622, it should be appreciated that the first distance 620 may alternatively be greater than the second distance 622. It should be further appreciated that one of the distances 620 and 622 may be zero, such that one of the side walls 602 or 605 is vertically aligned with the corresponding adjacent tab 604.

The cover 600 defines a first centerline 626 that is transversely elongate and extends substantially perpendicular with respect to the upper wall 606, and bisects the width of the cover 600, and bisects the first lateral width 610 between the side walls 602 and 605. Thus, the first centerline 626 is equidistantly spaced from both side walls 602 and 605. The cover 600 further defines a second centerline 624 that is transversely elongate and extends substantially perpendicular to the upper wall 606 of the cover 600, and bisects the second width 612 between the mounting tabs 604. Thus, the second centerline 626 is equidistantly spaced from both mounting tabs 604. The first and second centerlines 624 and 626 can be offset with respect to each other. For instance, the offset between the first and second centerlines 624 and 626 can be substantially equal to a corresponding offset between the contact pad 104 and an outer perimeter 103 of the smart card body 102 (see FIG. 1).

Referring now to FIGS. 2A-3C, the connector housing 200 further defines a pair of solder reflow notches 220 that protrude into the lower surface 212 of the connector housing 200 at a location aligned with the slots 216. In accordance with the illustrated embodiment, the solder reflow notches 220 1) extend laterally from a location aligned with the slots 216 through the corresponding side walls 227 and 229, respectively, and 2) are defined between the opposed front and rear ends 209 and 211. The solder reflow notches 220 are configured to facilitate solder reflow under the connector housing 200 at a location in alignment with the slots 216, thereby allowing the cover 600 to be reflowed directly to the printed circuit board 210 when the cover 600 is disposed in the slots 216. When the cover 600 is mounted to the connector housing 200, the mounting tabs 604 can extend through the slots 216 to a depth such that the leading ends 618 are substantially flush with or extend past the lower surface 212 of the connector housing 200 and into the reflow notches 220. The mounting tabs 604 may each have respective serrated side edges (not shown) that each engage respective inner walls of the slots 216 when the mounting tabs 604 are inserted into the slots 216. When the smart card connector 300 is mounted to the underlying printed circuit board 210, the leading edge 617 can be open to the printed circuit board 210 and soldered to the printed circuit board 210.

Referring to FIG. 2C and FIG. 4 in particular, the smart card connector 300 defines connector housing 200 defines a lateral width 512 (which is substantially perpendicular to the insertion direction 326) between the side walls 227 and 229. In accordance with the illustrated embodiment, the lateral width 512 of the connector housing 200 is less than the width 610 of the cover 600 that also extends along a direction substantially perpendicular with respect to the insertion direction 326. For example, the width 512 of the connector housing 200 measured in a direction that is perpendicular to the first direction may be sufficiently narrower than the width 610 of the cover 600, such that a portion of the printed circuit board 210 that is beneath the cover 600 but not occupied by the connector housing 200 may be used for other components. Thus, it can be said that the connector housing 200 is narrower than the cover 600 with respect to a direction that is substantially perpendicular to the insertion direction 326.

The electrical connector 300 defines a centerline 506 that extends longitudinally and is thus extends through a center of the connector housing 200, such that the centerline 506 is substantially equidistantly spaced from both side walls 227 and 229. Thus, the centerline 506 extends substantially parallel to or extends along the insertion direction 326. Accordingly, the centerline 506 may be defined by the insertion direction 326 such that it bisects the width 512 of the connector housing 200. Similarly, the centerline 626 of the cover 600 that bisects the upper wall 606 of the cover 600 extends substantially parallel to or along the insertion direction 326, and thus substantially parallel to the centerline 506. Accordingly, the centerline 626 of the cover 600 can be defined by the insertion direction 326 such that it bisects the width 610 of the cover 600, or is substantially equidistantly spaced from the side walls 602 and 605. In accordance with the illustrated embodiment, the centerline 626 of the cover 600 is offset from the centerline 506 of the connector housing 200 when the cover 300 is attached to the connector hosing 200. For instance, the offset between the centerlines 506 and 626 can be substantially equal to a corresponding offset between the contact pad 104 and an outer perimeter 103 of the smart card body 102 (see FIG. 1).

The smart card connector 300 further defines a first dimension 526, measured in a direction substantially perpendicular to the insertion direction 326, between the first side wall 227 of the connector housing 200 and the first side wall 602 of the cover 600, and a second distance 532 measured in a direction substantially perpendicular to the insertion direction 326, between the second side wall 229 of the connector housing 200 and the second side wall 605 of the cover 600. In accordance with the illustrated embodiment, the first lateral distance 526 is different than the second lateral distance 532. For instance, the first lateral distance 526 can be less than the second lateral distance 532. The distances 526 and 532, individually, may be any value including zero.

In an embodiment, a portion of the connector housing 200 may extend to be coextensive with the width 610 of the cover 600 while still reserving a fair amount of the underlying printed circuit board 210 for other components. The portion of the connector housing 200 that extends be coextensive with the width 610 of the cover 600 may be a narrow strip portion. Thus, the lateral width 512 of the connector housing 200 is narrower than the width 610 of the cover 600. The cover 600 further defines a longitudinal dimension 613 between a front end 625 and a longitudinally opposed rear end 627 that is less than the longitudinal distance between the front and rear ends 209 and 211 of the connector housing 200.

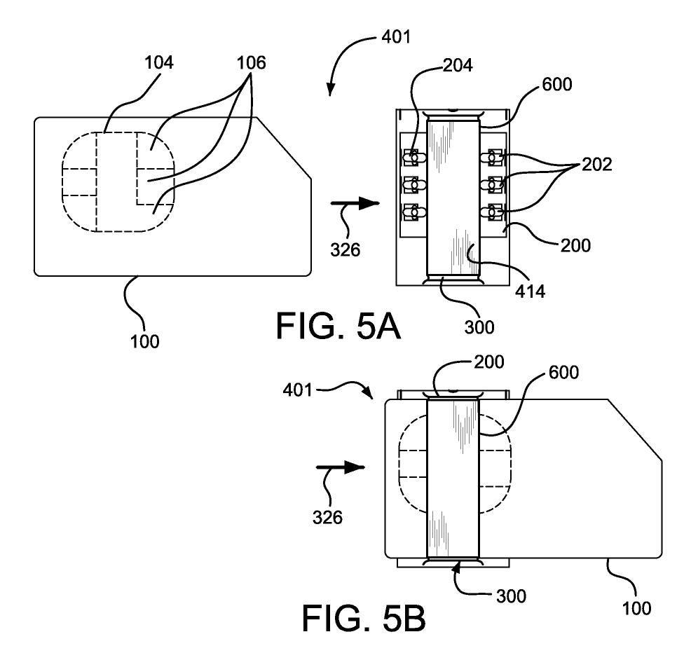

Referring also to FIGS. 5A-B, a smart card assembly 401 includes a smart card such as the smart card 100 as described above and the smart card connector 300. The smart card 100 can be mated with the smart card connector 300 by inserting the smart card 100 into the retention channel 614 along the insertion direction 326. The smart card 100 is configured to be inserted into the front end in a direction toward the rear end. In this regard, it should be appreciated that the relative positions of the front and rear ends 209 and 211 of the connector housing 200 can be reversed depending on the direction of smart card insertion.

As illustrated in FIG. 5A, the contact pad 104 of the smart card 100 may be positioned in a desired insertion orientation such that the contact pad 104 faces down and the electrical contacts 202 of the smart card connector 300 may be positioned facing up. Thus, the contact pad 104 and electrical contacts 106 of the smart card 100 face the mating ends 204 of the electrical contacts 202 when the smart card 100 is in the desired insertion orientation. As illustrated in FIG. 5B, the smart card 100 may be inserted into the smart card connector 300 in the insertion direction 326 such that when inserted, the contacts 106 of the smart card 100 establish electrical conductivity with the electrical contacts 202 of the smart card connector 300.

The mating ends 204 of the electrical contacts 202 may be resilient (such as spring-loaded contacts, spoon contacts, or the like) as described above. Accordingly, the mating ends 204 can compress transversely inward when the smart card 100 is inserted into the smart card connector 300. The inner surface of the upper wall 606 of the cover 600 can provide a normal transverse force on the smart card 100 counter to the upward force of the electrical contacts 202 on the smart card 300. The force from the contacts 106 and the upper inner surface of the cover 600 secures the smart card 100 in place when it is inserted into the smart card connector 300. Otherwise stated, the smart card connector 300 can define a gap having a first distance between the mating ends 204 and the upper wall 606 that is less than the transverse thickness of the card body 102 before the smart card 100 is inserted into the smart card connector 300. The first distance expands to a second distance that is greater than the first distance and substantially equal to the transverse thickness of the card body 102 when the smart card 100 is inserted into the smart card connector 300. The mating ends 204 can extend above the upper wall 606 before the smart card 100 is inserted into the smart card connector 300 if desired.

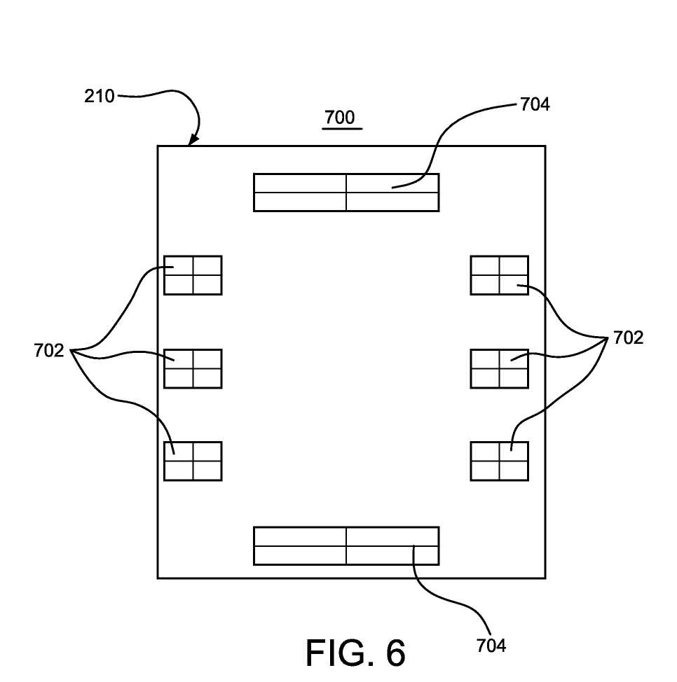

Referring now to FIG. 6, the printed circuit board 210 can define an example layout pattern 700 of first and second groups 702a and 702b of at least one electrical contact pads 702 configured to mate with complementary ones of the mounting ends 206 of the electrical contacts 202. The layout pattern 700 can further include at least one solder pads 704 configured to attach to the cover 600. When mounting the smart card connector 300 to the printed circuit board 210, the mounting ends 206 of the electrical contacts 202 and/or portions of the cover 600 may be soldered to the contact pads 702 of the printed circuit board 210. The solder pads 704 can be secured (e.g., soldered) to the mounting tabs 604 of the cover 600, for instance at the leading edges 618, thereby securing the metal cover 600 to the printed circuit board 210 and additional structural integrity to the smart card connector 300. When the cover 600 is soldered to the solder pads 704, the cover 600 can become electrically grounded, and can thus provide electrical shielding to the smart card 100 and smart card connector 300. The position of the contact solder pads 702 and the cover solder pads 706 may correspond to the relative position of the mounting ends 206 of the electrical contacts 202 and the mounting tabs 604 of the cover 600, respectively.

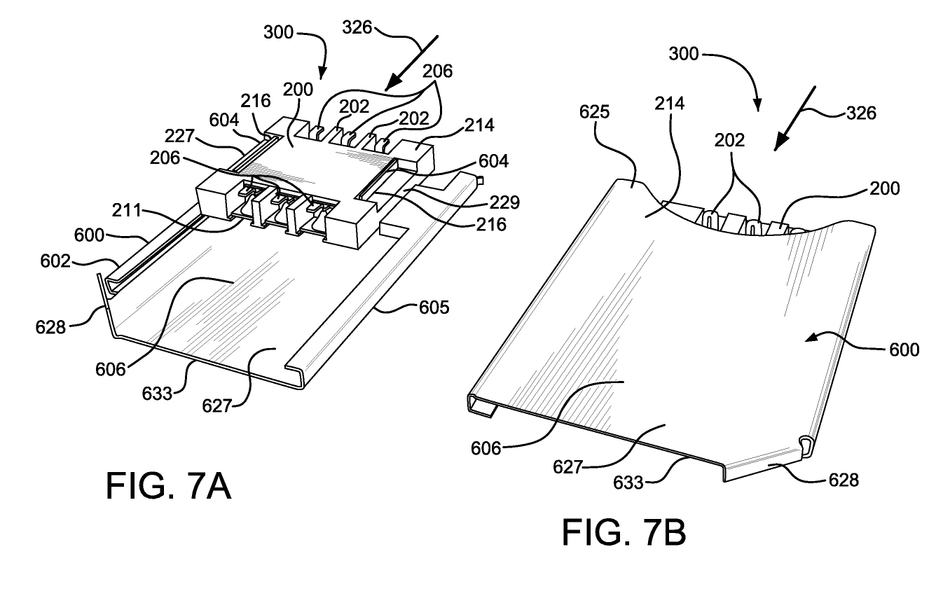

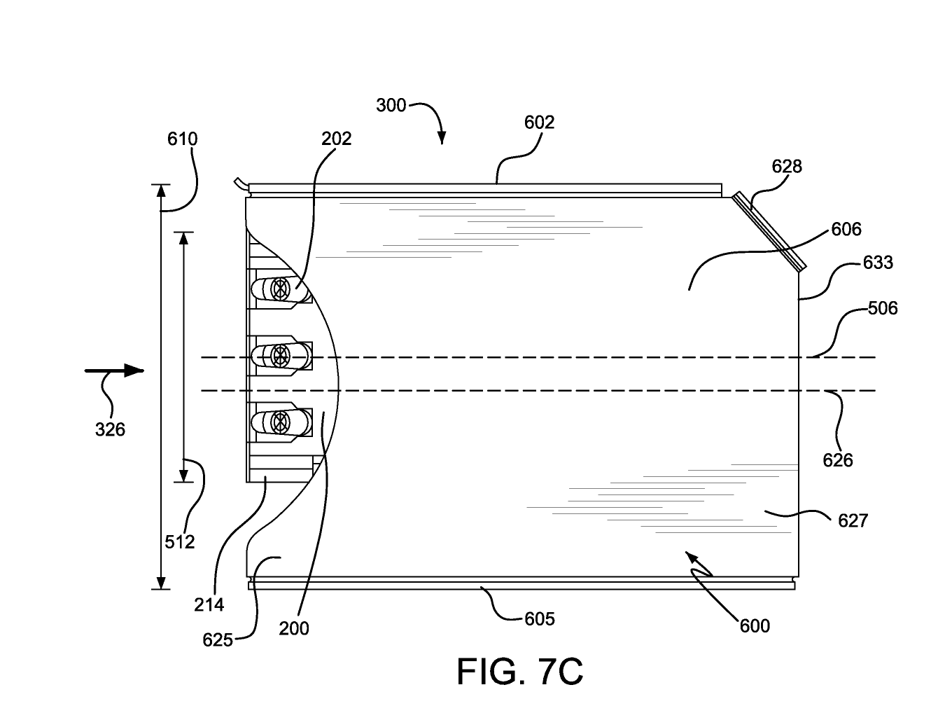

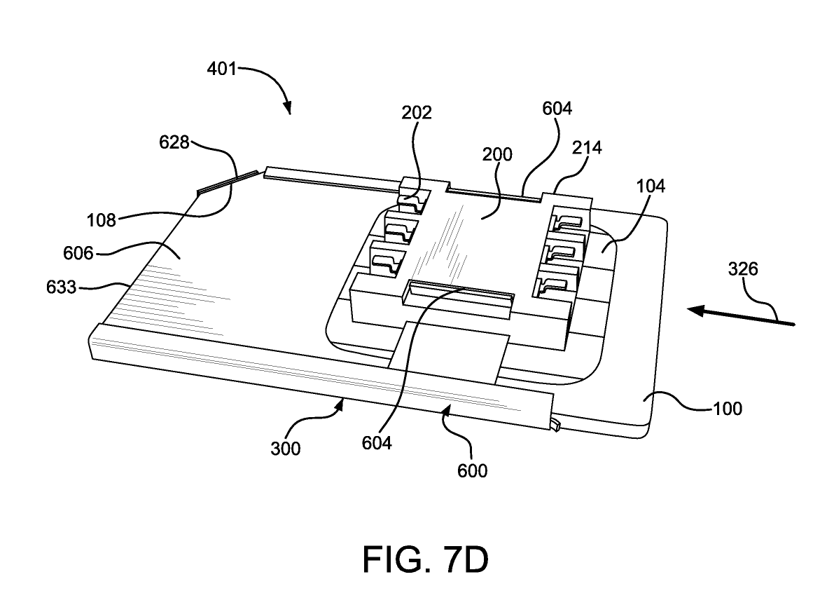

Referring now to FIGS. 7A-C, the smart card connector 300 can include the connector body connector body 214 and a cover 600 constructed in accordance with an alternative embodiment that is mounted or otherwise attached to the connector body 214 in the manner described above with respect to the cover 600. For instance, the upper wall 606 can include a rear tip 633 that can define a beveled stop 628 that extends down from the upper wall 606 of the cover 600 at the rear end 627. The rear end 627 can extend beyond the connector housing 200 with respect to the insertion direction 326, such that the rear end 211 of the connector housing 200 is disposed longitudinally between the front end rear ends 625 and 627 of the connector housing 200. The stop 628 can have a transverse depth less than the distance between the upper wall 606 and the lower surface 212 of the connector housing 200. Accordingly, the stop 628 terminates at a location above the printed circuit board 210 when the cover 600 is attached to the smart card connector 300, and the smart card connector is mounted to the printed circuit board 210. The stop 628 can be longitudinally aligned with the notch 108 of the smart card 100 when the smart card 100 is inserted into the smart card connector 300 along the insertion direction 326. Accordingly, the smart card 100 can be inserted along the insertion direction 326 until the notch 108 abuts the stop 628, which prevents the smart card 100 from being further inserted along the insertion direction 326. Thus, when the notch 108 abuts the stop 628, the smart card 100 is fully inserted in the smart card connector 300 such that the electrical contacts 106 mate with the mounting ends 206 of the electrical contacts 202 in the manner described above.

The stop 628 may be oriented so as to define an acute angle relative to the insertion direction 326 as illustrated, or can alternatively be oriented perpendicular to the insertion direction 326. When the stop 628 is disposed on an angle relative to the insertion direction 326, the stop 628 may serve as an orienting feature of the connector. For example, a smart card with an orienting notch (see orienting notch 108 as shown in FIG. 1) may be inserted into the smart card connector 300 along the insertion direction 326 into a void between the connector body 214 and an upper wall 606 of the cover 600. The orienting notch 108 of the smart card 100 can then mate with an orienting stop 628 of the cover 600. Thus, the orienting stop 628 and the orienting notch 108 may ensure that the smart card is properly inserted. The orienting stop 628 and the orienting notch 108 may ensure that when the smart card is inserted, the contacts 106 of the smart card 100 face the contacts 202 of the smart card connector 300.

Referring now also to FIG. 7D, the smart card assembly 401 includes a smart card such as smart card 100 inserted into the void defined by the connector housing 200 and the cover 600. When inserted in the insertion direction 326, the smart card 100 may be fully inserted into the smart card connector 300 until the orientation notch 108 of the smart card 100 abuts the stop 628 of the cover 600. The orientation notch 108 and the stop 628 may be complementarily angled to provide orientation and to prevent the smart card 100 from being inserted into the smart card connector 300 upside down. The electrical contacts 202 of the smart card connector 300 engage the contacts 106 of the smart card 100 when the smart card 100 is fully inserted.

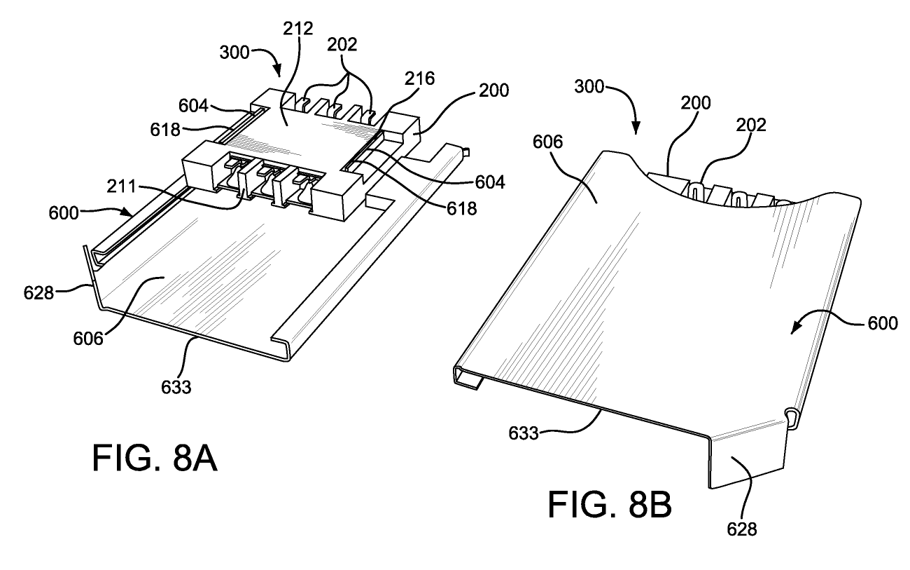

Referring now to FIGS. 8A-B, the cover 600 can be constructed in accordance with an alternative embodiment, whereby the stop 628 extends from the rear tip 633 of the upper surface 606 to a transverse depth substantially equal to the transverse distance between the upper surface 606 and the lower surface 212. Accordingly, the stop 628 can terminate at a location coplanar with the printed circuit board 210, and thus can abut the printed circuit board 210, when the smart card connector 300 is mounted to the printed circuit board 210 and the cover 600 is attached to the smart card connector 300. Accordingly, the smart card connector 300 may be supported by mounting the mounting ends of the contacts 202, the leading edges 618 of the mounting tabs 604, and the stop 628 to the underlying printed circuit board 210. Thus, the extended stop 1102 may provide additional stability for the smart card connector 300.

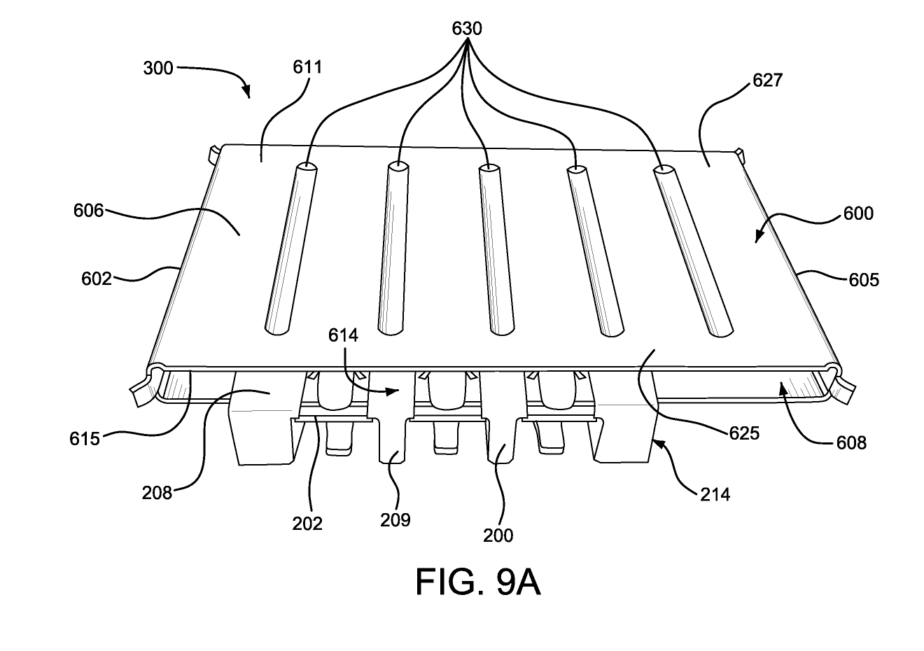

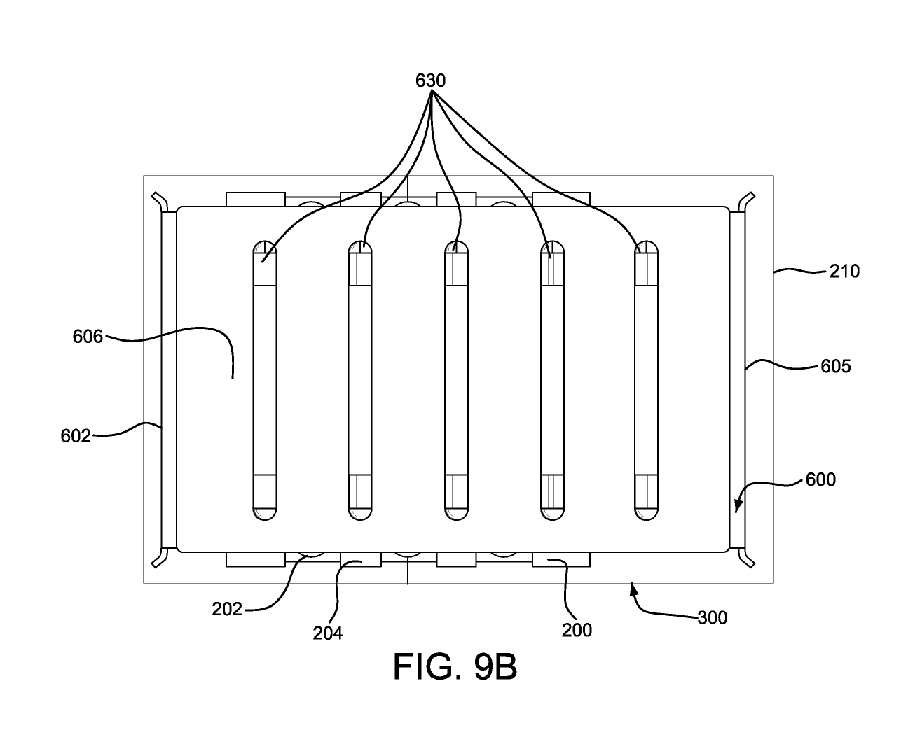

Referring now to FIGS. 9A-B, it is recognized the cover 600 can include at least one dimple 630 such as a plurality of dimples 630 that extend transversely down into an upper surface 611 of the upper wall 606 so as to extend down from an opposed lower surface 615 of the upper wall 606 and into the retention channel 614. Thus, the dimples 630 may enhance the normal force on the smart card. For example, the dimples 630 may provide additional pressure points on that portion of the smart card 100 that in turn receives an upward force from the spring-loaded spoon contacts 202 that biases the smart card 100 against the dimples 630. This additional pressure may reduce the possibility that the contacts 106 of the smart card 100 and the electrical contacts 202 of the connector body 214 may lose their electrically conductive connection. Accordingly, the additional pressure may reduce the effects of a problem known as SIM bounce that can cause the electrical contacts 202 to become disengaged from the electrical contacts 106 of the smart card 100 during operation. While the dimples 630 can be longitudinally elongate along the upper wall 606 at a location between the front end 625 and the rear end 627, it should be appreciated that the dimples 630 can assume any suitable alternative size and shape as desired. For instance, the dimples 630 can alternatively extend to one or both of the front and rear ends 625 and 627. It should be appreciated that the cover 600 can be provided with or without the stop 628 as described above, and with or without the dimples 630, or with one or both of the stops 628 and the dimples 630.

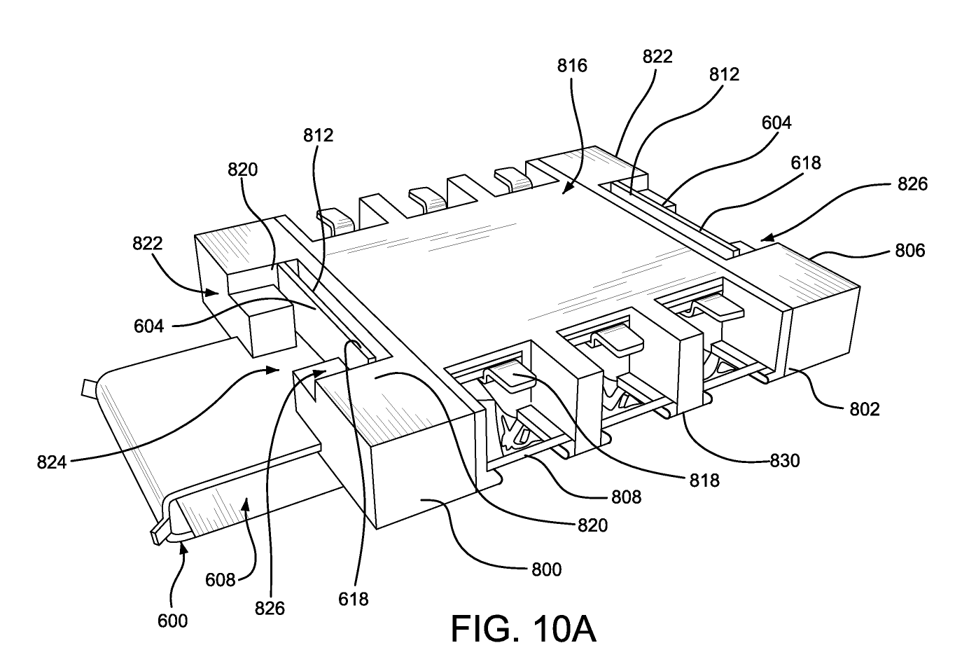

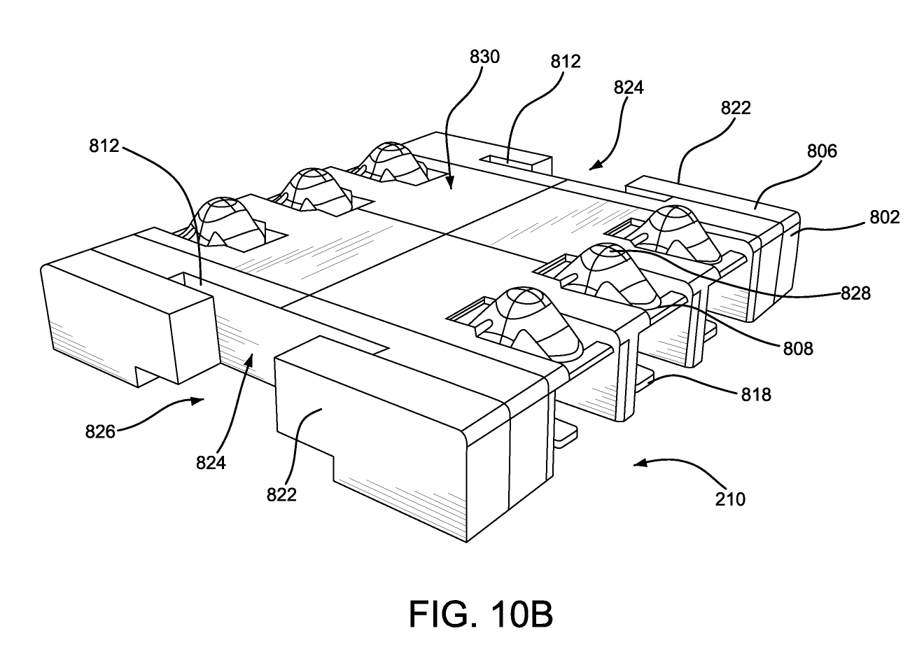

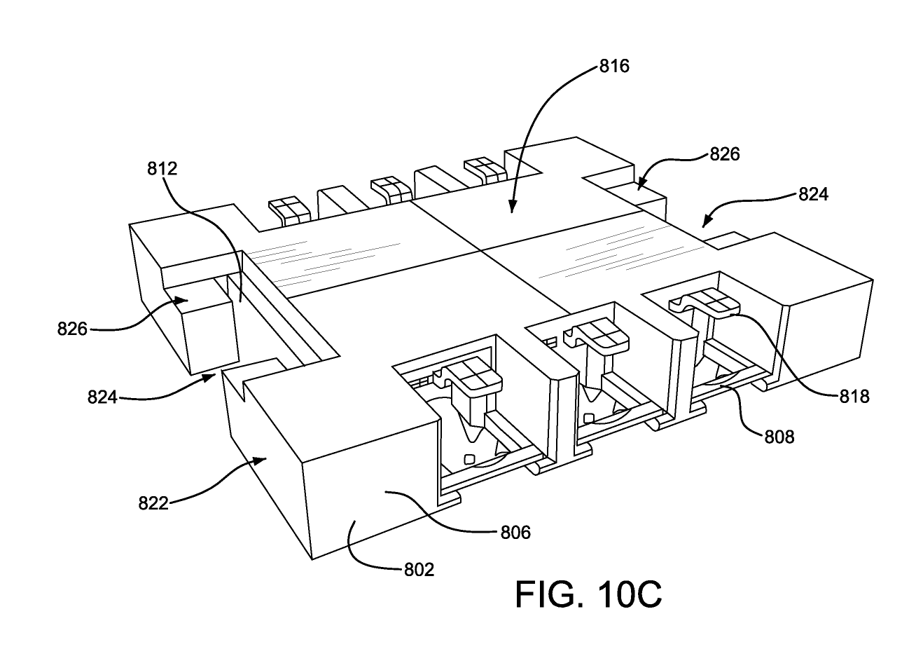

Referring now to FIGS. 10A-C, an example smart card connector 800 constructed in accordance with an alternative embodiment includes a connector body 802 and a cover such as the cover 600 that is configured to be connected to the connector body 802. The connector body 802 includes a connector housing 806 that carries a plurality of electrical contacts 808. The electrical contacts 808 may define respective mounting ends 818 and respective mating ends 210. The connector housing 806 may define one or more slots 812 configured to connect the connector body 802 to the cover 600 in the manner described above with respect to the smart card connector 300. In particular, the mounting tabs 604 may be received in the one or more slots 812 of the connector housing 806 such that the leading edges 618 of the mounting tabs 604 may be flush with the mounting ends 818 of the electrical contacts 808 when the mounting tabs 604 are fully inserted into the slots 812. The slots 812 may be disposed adjacent to side walls 822 of the connector housing 806.

The smart card connector 800 can thus be constructed as described above with respect to the smart card connector 300. However, the connector housing 806 includes one or more openings 824 that extend laterally through one or both of the side walls 822 and into the corresponding slot 812. The opening 824 can define a longitudinal dimension less than that of the slot 812, and can be substantially longitudinally centered in the slot 812. Thus, the slots 812 can be partially open to the adjacent side walls 822. The opening 824 may extend transversely through the connector housing 806, from the upper surface 830 through the lower surface 816. Furthermore, the smart card connector 800 can define one or more notches 826 that extend into the lower surface 816 of the connector housing 806 at a location in alignment with a corresponding slot 812. Each notch 826 extends from the corresponding slot 812 to the corresponding adjacent side wall 822. The combination of notches 826 and partial openings 824 may facilitate solder reflow when the leading end 618 of the mounting tabs 604 are soldered to the printed circuit board 210.

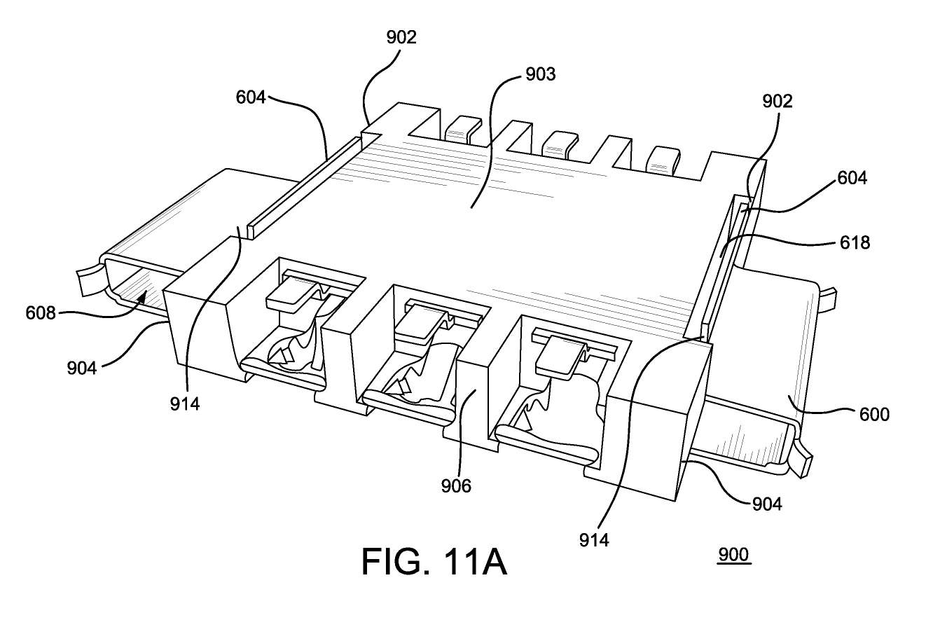

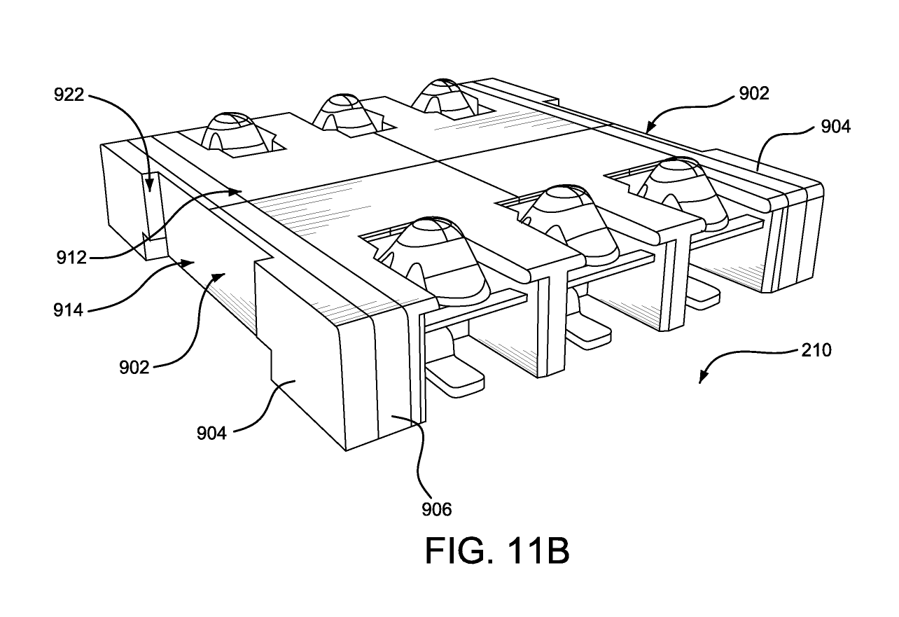

Referring now to FIGS. 11A-B, an example smart card connector 900 constructed in accordance with another embodiment is constructed substantially as described above with respect to the smart card connectors 300 and 800. Thus, the smart card connector 900 includes a connector housing 906 that defines one or more slots 902 extending in the side walls 904 of the connector housing 906. Similar to the slots 812 illustrated in FIGS. 10A-C, the slots 902 receive tabs 604 of the cover 600. The slots 902 extend along their respective side walls 904 from an upper surface 912 of the connector housing 906 through to the opposed lower surface of the connector housing 906.

However, unlike the smart card connectors 300 and 800, the smart card connector 900 further include one or more openings 914 extend laterally through one or both of the side walls 904 and into the corresponding slot 812. Thus, the slots 902 are fully open to the adjacent side walls 904. It should be appreciated that a smart card connector can include a slot configured to receive a cover, such that the slot is at least partially open to an adjacent side wall of the connector housing. The openings 914 can define a longitudinal dimension substantially equal to that of the corresponding slots 902, such that the openings 824 are longitudinally aligned with the corresponding slots 902. It should be further appreciated that the slots 902 can be formed integrally with the openings 914. When the cover 600 is attached to the connector housing 906, a longitudinal entirety of the mounting tabs 604 fit within the slots 902, particularly at the lower surface 903 of the connector housing 906 to facilitate solder reflow. The larger opening of the widened portion 914 may serve to facilitate solder reflow of the leading edges 618 of the mounting tabs 604 to the printed circuit board 210. In the illustrated embodiment, the slots 902 extend at least an entirety of the height of the mounting tabs 604 so that the entire tabs 604 fit within the respective slots 902.

The foregoing description is provided for the purpose of explanation and is not to be construed as limiting the invention. While various embodiments have been described with reference to preferred embodiments or preferred methods, it is understood that the words which have been used herein are words of description and illustration, rather than words of limitation. Furthermore, although the embodiments have been described herein with reference to particular structure, methods, and embodiments, the invention is not intended to be limited to the particulars disclosed herein. Additionally, it should be understood that the concepts described above with the above-described embodiments may be employed alone or in combination with any of the other embodiments described above. Those skilled in the relevant art, having the benefit of the teachings of this specification, may effect numerous modifications to the invention as described herein, and changes may be made without departing from the spirit and scope of the invention as defined by the appended claims.

What is claimed:

1. An electrical connector configured to receive a smart card, the electrical comprising:
a connector housing that carries at least one electrical contact and defines first and second slots; and
a cover comprising first and second opposed side walls that at least partially define an internal void configured to receive the smart card along an insertion direction and first and second mounting tabs connected to the first and second opposed side walls, respectively, wherein the first and second mounting tabs each received in a corresponding one of the first and second slots.

2. The electrical connector as recited in claim 1, wherein the connector housing further defines a pair of solder reflow notches at a location aligned with the first and second slots so as to facilitate solder reflow.

3. The electrical connector as recited in claim 1, wherein the first and second mounting tabs each define respective leading edges that are substantially flush with a lower surface of the connector housing when the cover is attached to the connector housing.

4. The electrical connector as recited in claim 1, wherein the electrical contact defines a spring-loaded mating end configured to electrically connect to a complementary electrical contact of the smart card.

5. The electrical connector as recited in claim 4, wherein the cover defines an upper wall configured to provide a normal force against the smart card when the smart card is inserted in the channel between the spring loaded spoon contact and the upper wall.

6. The electrical connector as recited in claim 5, wherein the upper wall has at least one dimple extending into the channel so as to provide an additional the normal force against the smart card.

7. The electrical connector as recited in claim 1, wherein the cover extends beyond the connector housing with respect to the insertion direction.

8. The electrical connector as recited in claim 7, further comprising a stop disposed at a rear end of the cover.

9. The electrical connector as recited in claim 8, wherein the stop extends to a location substantially coplanar with a lower surface of the connector housing.

10. The electrical connector as recited in claim 1, wherein the cover has a T-shape cross section in the first direction.

11. The electrical connector as recited in claim 1, wherein the cover comprises a pair of opposed side walls that define different dimensions to the connector housing when the cover is attached to the connector housing.

12. The electrical connector as recited in claim 1, wherein the cover defines a pair of opposed side walls and a first centerline that extends equidistantly from the opposed side walls, the connector housing defines a pair of opposed side walls and a second centerline that extends equidistantly from the opposed side walls of the connector housing, and the first centerline is offset from the second centerline.

13. An electrical connector for receiving a smart card, comprising:
a connector housing;
a cover connected to the housing, wherein the connector housing and the cover define a channel for receiving a smart card along an insertion direction, wherein the first connector housing defines a first centerline that extends in the insertion direction, the cover defines a second centerline that extends in the insertion direction, and the first centerline is offset from the second centerline.

14. A cover for a smart card connector, the cover comprising:
first and second opposed side walls that at least partially define an internal void configured to receive a smart card along an insertion direction;
first and second mounting tabs connected to the first and second side walls, respectively, the first and second mounting tabs each configured to attach to a connector housing, wherein the cover defines a first distance between the first and second tabs in direction that is substantially perpendicular to the insertion direction, the cover defines a second distance between the first and second opposed side walls in the direction that is substantially perpendicular to the insertion direction, and the first distance is less than the second distance.

15. An electrical connector configured to receive a smart card and further configured to be mounted onto a substrate, the electrical comprising:
a connector housing that carries at least one electrical contact; and
a cover comprising configured to be attached to the housing, such that the cover and the housing combine to at least partially define a retention chamber that receives the smart card so as to prevent movement of the smart card relative to the connector housing along a direction that is substantially perpendicular to the insertion direction and substantially parallel to the printed circuit board when the electrical connector is mounted to the printed circuit board.
